(19) United States
(12) Patent Application Publication
(10) Pub. No.: US 2011/0233302 A1
(43) Pub. Date: Sep. 29, 2011

(54) NEBULIZING ASSEMBLY

(75) Inventors: CHIEN-HUA LIN, TAOYUAN HSIEN (TW); CHIA-CHEN HUANG, TAOYUAN HSIEN (TW); LIANG-WEI LIU, TAOYUAN HSIEN (TW); TAI-SHUAN LIN, TAOYUAN HSIEN (TW); YU-CHUNG HSU, TAIPEI CITY (TW); CHIEH-MING HSIUNG, TAOUAN HSIEN (TW); MEI-HUI HUANG, TAOYUAN HSIEN (TW)

(73) Assignee: MICRO BASE TECHNOLOGY CORPORATION, TAOYUAN HSIEN (TW)

(21) Appl. No.: 13/051,550

(22) Filed: Mar. 18, 2011

(30) Foreign Application Priority Data
Mar. 24, 2010 (TW) 099108811

(51) Int. Cl. B05B 1/08

(52) U.S. Cl. 239/102.2

(57) ABSTRACT

A nebulizing assembly includes a base having a centered through hole; an nebulizing plate disposed on the base, the nebulizing plate having a radially outer area formed as a gluing section provided with a plurality of glue holes and a central area formed as a spraying section corresponding to the through hole on the base; and a piezoelectric driving element stacked on a top of the nebulizing plate and attached to the gluing section, and having a centered mist outlet. A glue layer is applied over the gluing section to fill up all the glue holes and can provide an extremely high bonding force when becoming dried to thereby firmly bond the nebulizing plate between the base and the piezoelectric driving element. The mist outlet and the through hole on the base have the same diameter to enable minimized resistance applied the whole structure to the nebulizing plate.

### FIELD OF THE INVENTION

The present invention relates to a nebulizing assembly, and more particularly to a device that oscillates at high speed to convert a working liquid into mist for use.

### BACKGROUND OF THE INVENTION

The conversion of a working liquid into mist by way of high-speed vibration has been widely applied in medicine or aromatizing agent dispersion. To do so, a nebulizing assembly is provided in a nebulizer at a working liquid pumping end thereof. Through piezoelectric conversion, the nebulizing assembly produces high-frequency micro-amplitude vibration waves to thereby cut the surface of the working liquid, so that fine mist with vectored impact is formed. And, as a result of Brownian motion effect, aromatizing agent can be mixed into air to change the property of air, or medication in the form of mist can be produced for inhalation therapy. In addition to the applications of forming aromatized air and producing medication in the form of mist, the nebulizing assembly can also be used in areas or countries having dry climate to provide humidified air indoors.

According to the currently available techniques, a nebulizing assembly includes a plurality of stacked micro sheets being packaged together, and these micro sheets generally include at least a piezoelectric plate, a nebulizing plate, and fixtures. Currently, these micro sheets connected to one another are adopts an adhesive medium. Please refer to FIG. 1 that shows a first conventional way of packaging the nebulizing assembly. As shown, for the purpose of lowering the manufacturing cost by using simple packaging process, the thin-sheet components are packaged by applying a gluing substance 83 on the flat contact surfaces between them. The gluing substance 83 applied on the planar junctions between the piezoelectric plate 81 and the nebulizing plate 82 tends to become separated, peeled off, broken or collapsed when the nebulizing assembly vibrates at high speed during operation thereof to thereby result in shortening the usable life of the nebulizer. FIG. 2 shows another conventional way of packaging the nebulizing assembly. In FIG. 2, two fixtures 84 are used to clamp at an upper and a lower side of the nebulizing plate 82 to provide the function of holding the nebulizing plate 82 in place. In practical use of the nebulizing assembly shown in FIG. 2, the fixtures 84 will suppress an oscillation performance of the nebulizing plate 82. Therefore, the design of the nebulizing assembly of FIG. 2 fails to consider the manufacturing cost and the working performance at the same time. It is therefore tried by the inventor to develop a nebulizing assembly that is able to eliminate the drawbacks in the conventional nebulizing assemblies and is accordingly more practical for use.

### SUMMARY OF THE INVENTION

A primary object of the present invention is to provide a nebulizing assembly to eliminate the drawbacks in the currently available nebulizing assemblies.

To achieve the above and other objects, the nebulizing assembly according to the present invention includes a base, a nebulizing plate, and a piezoelectric driving element. The base is a thin plate and has a through hole formed at a center thereof. The nebulizing plate is a thin sheet, is disposed on a top of the base, and includes a gluing section and a spraying section. The gluing section is located at a radially outer area of the nebulizing plate to be correspondingly positioned on an upper surface of the base and is perforated to provide a plurality of glue holes. The spraying section is located at a central area of the nebulizing plate corresponding to the through hole of the base, and is perforated to provide a plurality of densely distributed fine mist holes. The piezoelectric driving element is stacked on a top of the nebulizing plate, and attached to the gluing section of the nebulizing plate. The piezoelectric driving element is provided at a central area with a mist outlet, and the mist outlet is located at a position corresponding to the spraying section of the nebulizing plate. The gluing section adopts an adhesive medium as a packaging technique to firmly connect between the base and the piezoelectric driving element by gluing.

In gluing the nebulizing plate between the base and the piezoelectric driving element, the adhesive medium applied over the gluing section will flow into and fill up all the glue holes in the gluing section to form a glue layer. When the glue layer becomes dried, an extremely high bonding force can be provided between the dried glue layer and the nebulizing plate, preventing the glue layer from being structurally damaged when the whole nebulizing assembly vibrates to spray mist at high speed. In addition, since the mist outlet on the piezoelectric driving unit and the through hole on the base have the same diameter, it is able to minimize the resistance resulted from the fully packaged structure of the nebulizing assembly supplied to the nebulizing plate and to ensure good operation of the present invention in its actual applications. Further, the nebulizing plate in the present invention can provide good vibrating performance because it is not excessively clamped in place by other fixtures.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIGS. 1 and 2 show two nebulizing assemblies packaged in conventional ways and the drawbacks thereof;

FIG. 3 is an appearance view of a nebulizing assembly according to a preferred embodiment of the present invention;

FIG. 4 is an exploded view of the nebulizing assembly of the present invention; and

FIG. 5 is a sectioned side view of the nebulizing assembly of the present invention.

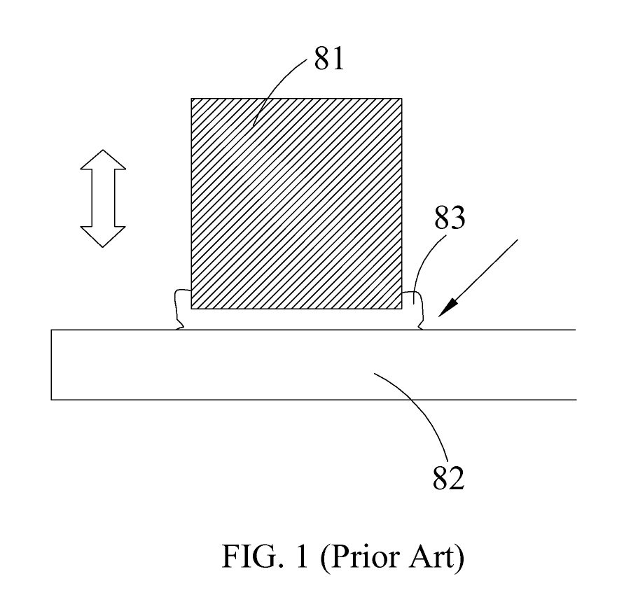

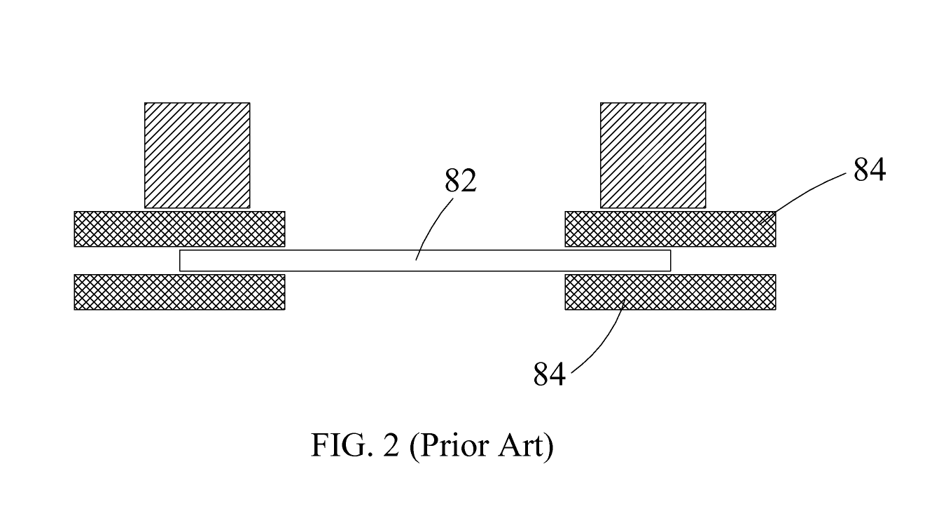

### DETAILED DESCRIPTION OF THE PREFERRED EMBODIMENTS

The present invention will now be described with a preferred embodiment thereof. It is understood the accompanying drawings are illustrated only for assisting in describing the preferred embodiment of the present invention and is not necessarily in compliance with the exact or precise size proportion and part arrangement of a real product manufactured through implementing the present invention. Therefore, the size proportion and part arrangement shown in the accompanying drawings are not intended to limit the present invention, which is limited only by the appended claims.

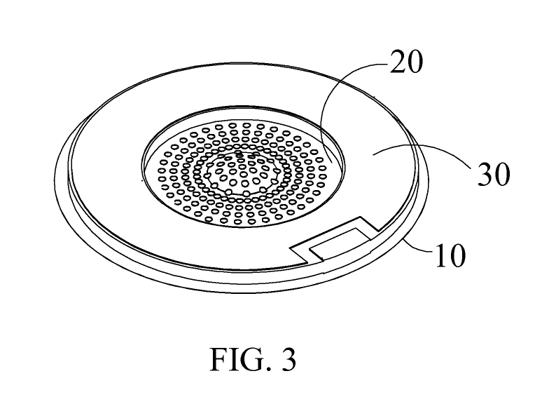

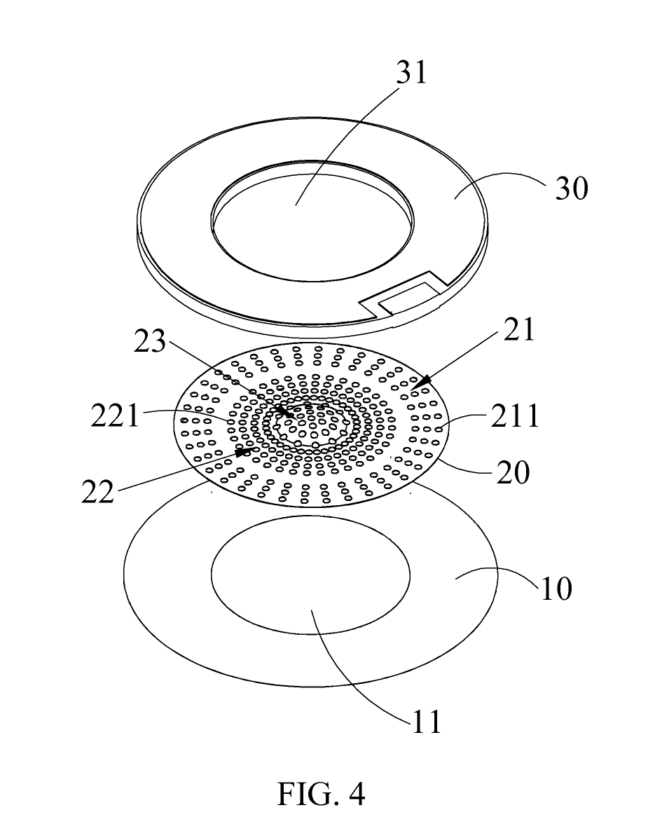

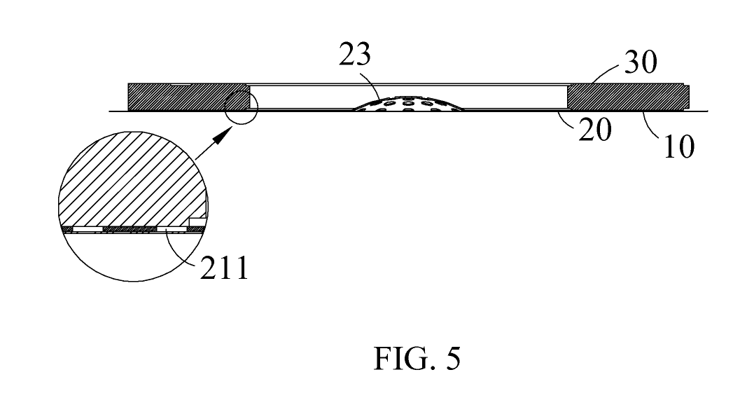

Please refer to FIGS. 3 to 5. The present invention relates to a nebulizing assembly applicable to a nebulizer. Through piezoelectric conversion, the nebulizing assembly produces high-frequency vibration to oscillate a working liquid in the nebulizer, such that vapor mist is produced and forced out of the nebulizer. In a preferred embodiment of the present invention, the nebulizing assembly includes a base 10, a nebulizing plate 20, and a piezoelectric driving element 30.

The base 10 can be a thin plate made of a metal material, such as stainless steel, a plastic material, an acrylic material or the like, and can be in circular, annular, rectangular or other simple geometric shape. The base 10 is provided at a center with a through hole 11, which can be circular, annular, rectangular or other simple geometric shape.

The nebulizing plate 20 can be a thin sheet in circular, annular, rectangular or other simple geometric shape, and is disposed on a top of the base 10. The nebulizing plate 20 includes a gluing section 21 and a spraying section 22. The gluing section 21 is located at a radially outer area of the nebulizing plate 20 to be correspondingly positioned on an upper surface of the base 10 and is perforated to provide a plurality of glue holes 211. The spraying section 22 is located at a central area of the nebulizing plate 20 corresponding to the through hole 11 of the base 10, and is perforated to provide a plurality of densely distributed fine mist holes 221. Further, a central area of the spraying section 22 is formed into an upward curved convex section 23.

The piezoelectric driving element 30 can be in circular, annular, rectangular or other simple geometric shape and is correspondingly stacked on a top of the nebulizing plate 20 and attached to the gluing section 21 of the nebulizing plate 20. The piezoelectric driving element 30 is provided at a central area with a through hole to serve as a mist outlet 31. The mist outlet 31 is in circular, annular, rectangular or other simple geometric shape, and is located at a position corresponding to the spraying section 22 of the nebulizing plate 20. The mist outlet 31 has a diameter identical to that of the through hole 11 on the base 10, so as to minimize a resistance applied thereto by the nebulizing assembly due to a stacked packaging structure having multiple differently sized layers. The gluing section 21 adopts an adhesive medium as a packaging technique to firmly connect to between the base 10 and the piezoelectric driving element 30. In the present invention, a curable adhesive, such as epoxy resin, can be used as the adhesive medium to form a glue layer bound the gluing section 21 of the nebulizing plate 20 between the base 10 and the piezoelectric driving element 30.

In the ingenious design of the nebulizing assembly of the present invention, the glue layer applied over the gluing section 21 of the nebulizing plate 20 will flow into and fill up all the glue holes 211 in the gluing section 21. When the glue layer becomes dried, an extremely high bonding force will exist between the dried glue layer and the nebulizing plate 20, which prevents the glue layer from being structurally damaged when the whole nebulizing assembly vibrates to spray mist at high speed. Thus, the problem of a failed product of nebulizer can be avoided. In addition, with the mist outlet 31 on the piezoelectric driving unit 30 being designed to have the same diameter as the through hole 11 on the base 10, the resistance resulted from the fully packaged structure of the nebulizing assembly supplied to the nebulizing plate 20 is minimized, ensuring good operation of the present invention in its actual applications. Further, unlike the prior art nebulizing assemblies, the nebulizing plate 20 in the present invention is not excessively clamped in place by other fixtures, and therefore, the vibration performance of the nebulizing plate 20 is not suppressed, making the nebulizing assembly of the present invention practical for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A nebulizing assembly comprising:
a base being a thin plate and having a through hole formed at a center thereof;
a nebulizing plate being a thin sheet, disposing on a top of the base, and including a gluing section and a spraying section; the gluing section being located at a radially outer area of the nebulizing plate to be correspondingly positioned on an upper surface of the base, and being perforated to provide a plurality of glue holes; and the spraying section being located at a central area of the nebulizing plate corresponding to the through hole of the base, and being perforated to form a plurality of densely distributed fine mist holes; and
a piezoelectric driving element stacking on a top of the nebulizing plate and attaching to the gluing section of the nebulizing plate; the piezoelectric driving element being provided at a central area with a mist outlet, and the mist outlet being located at a position corresponding to the spraying section of the nebulizing plate;
wherein, the gluing section adopts an adhesive medium as a packaging technique to firmly connect between the base and the piezoelectric driving element.

2. The nebulizing assembly as claimed in claim 1, wherein the mist outlet has a diameter identical to a diameter of the through hole on the base.

3. The nebulizing assembly as claimed in claim 2, wherein the piezoelectric driving element is circular, annular, rectangular, or any other geometric shape.

4. The nebulizing assembly as claimed in claim 3, wherein the nebulizing plate is circular, annular, rectangular, or any other geometric shape; and the mist outlet on the piezoelectric driving element is also circular, annular, rectangular, or any other geometric shape.

5. The nebulizing assembly as claimed in claim 4, wherein the base is circular, annular, rectangular, or any other geometric shape; and the through hole on the base is also circular, annular, rectangular, or any other geometric shape.

6. The nebulizing assembly as claimed in claim 5, wherein a center of the spraying section on the nebulizing plate has an upward curved convex section.

7. The nebulizing assembly as claimed in claim 6, wherein the base is made of a material selected from the group consisting of a metal material, a plastic material and an acrylic material; and a glue layer formed by the adhesive medium is made of a curable adhesive.

8. A nebulizing assembly comprising:
a base being a thin plate and having a through hole formed at a center thereof;
a nebulizing plate being a thin sheet, disposing on a top of the base, and including a gluing section and a spraying section; the gluing section being located at a radially outer area of the nebulizing plate to be correspondingly positioned on an upper surface of the base; and the spraying section being located at a central area of the nebulizing plate corresponding to the through hole of the base, and being perforated to provide a plurality of densely distributed fine mist holes; and
a piezoelectric driving element stacking on a top of the nebulizing plate and attaching to the gluing section of the nebulizing plate; the piezoelectric driving element being provided at a central area with a mist outlet, the mist outlet being located at a position corresponding to the spraying section of the nebulizing plate and having a diameter identical to a diameter of the through hole on the base; and
wherein, the gluing section adopts an adhesive medium as a packaging technique to firmly connect between the base and the piezoelectric driving element.

9. The nebulizing assembly as claimed in claim 8, wherein the piezoelectric driving element is circular, annular, rectangular, or any other geometric shape.

10. The nebulizing assembly as claimed in claim 9, wherein the nebulizing plate is circular, annular, rectangular, or any other geometric shape; and the mist outlet on the piezoelectric driving element is also circular, annular, rectangular, or any other geometric shape.

11. The nebulizing assembly as claimed in claim 10, wherein the base is circular, annular, rectangular, or any other geometric shape; and the through hole on the base is also circular, annular, rectangular, or any other geometric shape.

12. The nebulizing assembly as claimed in claim 11, wherein a center of the spraying section on the nebulizing plate has an upward curved convex section.

13. The nebulizing assembly as claimed in claim 12, wherein the base is made of a material selected from the group consisting of a metal material, a plastic material and an acrylic material; and a glue layer formed by the adhesive medium is made of a curable adhesive.
